(19) United States
(12) Patent Application Publication
(10) Pub. No.: US 2005/0056239 A1
(43) Pub. Date: Mar. 17, 2005

(54) Internal combustion engine variable compression ratio system

(75) Inventor: Makoto Hirano, Wako-shi (JP)

Correspondence Address: BIRCH STEWART KOLASCH & BIRCH, PO BOX 747, FALLS CHURCH, VA, 22040-0747, US

(73) Assignee: HONDA MOTOR CO., LTD., Tokyo (JP)

(21) Appl. No.: 10/901,064

(22) Filed: Jul. 29, 2004

(30) Foreign Application Priority Data
Jul. 31, 2003 (JP) 2003-284427

(51) Int. Cl. F02B 75/04

(52) U.S. Cl. 123/48 B

(57) ABSTRACT

An internal combustion engine variable compression ratio system. The system includes an inner piston connected to a connecting rod, an outer piston fitted around the outer periphery of the inner piston so that the outer piston can slide only in the axial direction, and a retaining ring fixedly provided on the outer piston so as to axially oppose a head portion with the inner piston interposed between the restricting means and the head portion. Also included are a first cam mechanism disposed between the inner piston and the head portion for controlling a first axial spacing therebetween, and a second cam mechanism disposed between the inner piston and the retaining ring for controlling a second axial spacing therebetween.

### CROSS-REFERENCE TO RELATED APPLICATION

The present application claims priority under 35 U.S.C. §119 to Japanese Patent Application Nos. 2003-284427, filed on Jul. 31, 2003, the entire contents of which are hereby incorporated by reference.

### BACKGROUND OF THE INVENTION

1. Field of the Invention

The present invention relates to an internal combustion engine variable compression ratio system, and in particular to an improvement thereof in which a piston includes an inner piston and a outer piston. The inner piston is connected to a connecting rod via a piston pin, and the outer piston being fitted slidably around the outer periphery of the inner piston and having a head portion facing a combustion chamber. An operating device disposed between the inner piston and the outer piston moves and holds the outer piston relative to the inner piston alternately at a low compression ratio position close to the piston pin and at a high compression ratio position close to the combustion chamber, thereby making the engine compression ratio variable.

2. Background Art

As a conventional internal combustion engine variable compression ratio system, there is a known system (1) in which an outer piston is screwed around the outer periphery of a inner piston, and the outer piston is rotated forward and backward so that it approaches and recedes from the inner piston to move to a low compression ratio position and a high compression ratio position (for example, Japanese Patent Application Laid-open No. 11-117779).

Another known system (2) includes an outer piston is fitted in an axially slidable manner around the outer periphery of a inner piston, an upper hydraulic chamber and a lower hydraulic chamber are formed between the inner piston and the outer piston, and supply of hydraulic pressure alternately to these hydraulic chambers moves the outer piston to a low compression ratio position and a high compression ratio position (for example, Japanese Patent Publication No. 7-113330).

However, in the above-mentioned system (1), since it is necessary to rotate the outer piston in order to move it to the low compression ratio position and the high compression ratio position, the shape of the top face of the outer piston cannot be set freely so as to match the shape of the roof of a combustion chamber and the positional arrangement of intake and exhaust valves, and it is difficult to sufficiently increase the compression ratio of the engine at the high compression ratio position. Furthermore, in the above-mentioned system (2), particularly when the outer piston is at the high compression ratio position, since a large thrust load acting on the outer piston during an expansion stroke of the engine is borne by the hydraulic pressure of the upper hydraulic chamber, it is necessary for the upper hydraulic chamber to have a seal that can withstand high pressure, and moreover if bubbles are generated in the upper hydraulic chamber, the high compression ratio position of the outer piston becomes unstable, so that it is necessary to provide means for removing such bubbles, thus inevitably increasing the overall cost.

### SUMMARY AND OBJECTS OF THE INVENTION

The present invention has been accomplished under the above-mentioned circumstances, and it is an object thereof to provide an internal combustion engine variable compression ratio system that enables an outer piston to be moved to and held at a low compression ratio position and a high compression ratio position simply and reliably without rotating the outer piston.

In order to attain this object, in accordance with a first aspect of the present invention, there is provided an internal combustion engine variable compression ratio system that includes an inner piston connected to a connecting rod via a piston pin, an outer piston with a head portion facing a combustion chamber and fitted around the outer periphery of the inner piston so that the outer piston can slide only in the axial direction. Also included are restricting means fixedly provided on the outer piston so as to axially oppose the head portion with the inner piston interposed between the restricting means and the head portion, a first cam mechanism that is disposed between the inner piston and the head portion and that controls a first axial spacing therebetween, and a second cam mechanism that is disposed between the inner piston and the restricting means and that controls a second axial spacing therebetween.

In addition, the first cam mechanism has a first rotating cam plate that is rotatable between first and second rotational positions around the axis of the inner piston, and is arranged so that the first cam mechanism axially compresses at the first rotational position of the first rotating cam plate so as to allow the first axial spacing to decrease and axially expands at the second rotational position so as to allow this axial spacing to increase. Further, the second cam mechanism has a second rotating cam plate that is rotatable between third and fourth rotational positions around the axis of the inner piston, and is arranged so that the second cam mechanism axially expands at the third rotational position of the second rotating cam plate so as to allow the second axial spacing to increase and axially compresses at the fourth rotational position so as to allow this axial spacing to decrease; and wherein the first and second rotating cam plates are connected to driving means for moving the first rotating cam plate to the first rotational position and moving the second rotating cam plate to the third rotational position so as to hold the outer piston at a low compression ratio position, and for moving the first rotating cam plate to the second rotational position and moving the second rotating cam plate to the fourth rotational position so as to hold the outer piston at a high compression ratio position.

The driving means corresponds to first and second actuators and of an embodiment of the present invention, which will be described later, and the restricting means corresponds to a retaining ring.

Furthermore, in accordance with a second aspect of the present invention, there is provided an internal combustion engine variable compression ratio system wherein the driving means includes a first actuator with first hydraulic operating means for moving the first rotating cam plate toward one of the first and second rotational positions and a first return spring urging the first rotating cam plate toward the other of the first and second rotational positions. A second actuator includes second hydraulic operating means for moving the second rotating cam plate toward one of the third and fourth rotational positions and a second return spring urging the second rotating cam plate toward the other of the third and fourth rotational positions.

The first hydraulic operating means corresponds to an operating plunger and a hydraulic chamber of the embodiment of the present invention, which will be described later, the second hydraulic operating means corresponds to an operating plunger and a hydraulic chamber the first return spring corresponds to a return spring, and the second return spring corresponds to a return spring.

Moreover, in accordance with a third aspect of the present invention, there is provided an internal combustion engine variable compression ratio system wherein the first hydraulic operating means is arranged so as to move the first rotating cam plate to the second rotational position when operated hydraulically, and wherein the second hydraulic operating means is arranged so as to move the second rotating cam plate to the fourth rotational position when operated hydraulically.

Furthermore, in accordance with a fourth aspect of the present invention, there is provided an internal combustion engine variable compression ratio system wherein supply and release of hydraulic pressure for the first and second hydraulic operating means are carried out by a common control valve.

Moreover, in accordance with a fifth aspect of the present invention, there is provided an internal combustion engine variable compression ratio system wherein release of hydraulic pressure from the first and second hydraulic operating means is started during an intake stroke of the internal combustion engine, and supply of hydraulic pressure to the first and second hydraulic operating means is started during an exhaust stroke of the internal combustion engine.

Furthermore, in accordance with a sixth aspect of the present invention, there is provided an internal combustion engine variable compression ratio system wherein there are provided a plurality of the first cam mechanisms and a plurality of the second cam mechanisms, the numbers thereof being the same.

Moreover, in accordance with a seventh aspect of the present invention, there is provided an internal combustion engine variable compression ratio system wherein the first rotating cam plate is supported by one of the inner piston and the outer piston in an axially immovable but pivotable manner, and a first fixed cam forming the first cam mechanism in cooperation with the first rotating cam plate is fixedly provided on the other one of the inner piston and the outer piston, and wherein the second rotating cam plate is supported by one of the inner piston and the outer piston in an axially immovable but pivotable manner, and a second fixed cam forming the second cam mechanism in cooperation with the second rotating cam plate is fixedly provided on the other one of the inner piston and the outer piston.

In accordance with the first aspect of the present invention, moving the first rotating cam plate to the first rotational position and the second rotating cam plate to the third rotational position using the driving means enables the outer piston to be moved to and held at a low compression position, which is closer to the piston pin relative to the inner piston; and moving the first rotating cam plate to the second rotational position and the second rotating cam plate to the fourth rotational position enables the outer piston to be moved to and held at a high compression position, which is closer to the combustion chamber relative to the inner piston, by virtue of axial expansion of the first cam mechanism and axial compression of the second cam mechanism.

Whether the outer piston is at the low compression ratio position or the high compression ratio position, the inner piston and the outer piston are always connected securely in the axial direction via the first and second cam mechanisms, and since the thrust load acting between the inner piston and the outer piston is carried mechanically by the first and second cam mechanisms, not only is it possible to increase the piston strength effectively but it is also possible to reduce the capacity of the driving means and, consequently, the dimensions thereof.

In particular, since the first cam mechanism allows the outer piston to move between the low compression ratio position and the high compression ratio position when the first rotating cam plate is at the first rotational position, and the second cam mechanism similarly allows the outer piston to move between the low compression ratio position and the high compression ratio position when the second rotating cam plate is at the fourth rotational position, the outer piston can be moved to the low compression ratio position and the high compression ratio position by utilizing an external force such as a difference in inertial force between the inner piston and the outer piston, the sliding resistance between the outer piston and the cylinder bore inner face, or negative pressure and positive pressure on the combustion chamber side. Moreover, since the driving means for rotating the first and second cam plates receives a zero or extremely small thrust load from the inner piston and the outer piston, it is possible to reduce the capacity of the driving means and, consequently, the dimensions thereof.

Furthermore, since the outer piston does not rotate relative to the inner piston, the head portion of the outer piston, which faces the combustion chamber, can match the shape of the combustion chamber, thereby effectively increasing the compression ratio when the outer piston is at the high compression ratio position.

Moreover, in accordance with the second aspect of the present invention, with regard to the first and second actuators, the hydraulic operating means can be formed as a structurally simple single-acting system, so that the driving means can be obtained at low cost. Moreover, since the hydraulic operating means of the first and second actuators receive a zero or extremely small thrust load from the inner piston and the outer piston, it is possible to reduce the capacity and the dimensions of the hydraulic operating means, and even if some bubbles are generated in the hydraulic chamber, the outer piston can be held stably at the low compression ratio position and the high compression ratio position without being affected by the bubbles.

Furthermore, in accordance with the third aspect of the present invention, in the event of the hydraulic pressure system malfunctioning, the operation of the return springs of the first and second actuators enables the outer piston to be automatically moved to and held at the low compression position.

Moreover, in accordance with the fourth aspect of the present invention, the hydraulic pressure control system for the first and second hydraulic operating means can be simplified, thereby reducing the cost.

Furthermore, in accordance with the fifth aspect of the present invention, by effectively utilizing a difference in inertial force between the inner piston and the outer piston it is possible to quickly move the outer piston from the high compression ratio position to the low compression ratio position, or from the low compression ratio position to the high compression ratio position.

Moreover, in accordance with the sixth aspect of the present invention, by combining axially compressed and expanded states of the first cam mechanisms and axially compressed and expanded states of the second cam mechanisms it is possible to control the compression ratio position of the outer piston by switching between three or more stages, that is, low, medium, high, etc.

Furthermore, in accordance with the seventh aspect of the present invention, since the first rotating cam plate and the first fixed cam are axially supported by one and the other of the inner piston and the outer piston respectively, and the second rotating cam plate and the second fixed cam are axially supported by one and the other of the inner piston and the outer piston respectively, is there no axial play in the fixed cams as well as in the pivoting cam plates while the inner piston and the outer piston are moving axially relative to each other. Therefore, when the first cam mechanism and the second cam mechanism alternately expand and compress by utilizing an external force such as a difference in inertial force between the inner piston and the outer piston, it is possible to reliably avoid mutual interference between each fixed cam and its corresponding rotating cam plate, thus reliably rotating the respective rotating cam plates to desired rotational positions by the driving force of the driving means, and thereby reliably holding the outer piston at desired low compression ratio position and high compression ratio position.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a vertical sectional front view of an essential part of an internal combustion engine provided with a variable compression ratio system related to a first embodiment of the present invention;

FIG. 2 is an enlarged view of an essential part of FIG. 1;

FIG. 3 is an enlarged sectional view, along line 3-3 in FIG. 2, showing a low compression ratio state;

FIG. 4 is a view, corresponding to FIG. 3, showing a high compression ratio state;

FIG. 5 is an enlarged sectional view along line 5-5 in FIG. 3;

FIG. 6 is an enlarged sectional view along line 6-6 in FIG. 3;

FIG. 7 is an enlarged sectional view along line 7-7 in FIG. 3;

FIG. 8 is an enlarged sectional view along line 8-8 in FIG. 3;

FIG. 9 is an enlarged sectional view along line 9-9 in FIG. 4;

FIG. 10 is an enlarged sectional view along line 10-10 in FIG. 3;

FIG. 11 is an enlarged sectional view along line 11-11 in FIG. 3;

FIG. 12 is an enlarged sectional view along line 12-12 in FIG. 4;

FIG. 13 is a chart showing the relationship between the compression ratio switching timing and the inertial force of a inner piston;

FIGS. 14A to 14D are diagrams for explaining the operation of switching from a high compression ratio state to a low compression ratio state;

FIGS. 15A to 15D are diagrams of the operation of switching from the low compression ratio state to the high compression ratio state;

FIGS. 16A to 16C are vertical sectional side views of an essential part of a variable compression ratio system showing a second embodiment of the present invention; and

FIGS. 17A to 17C are vertical sectional side views of an essential part of a variable compression ratio system showing a third embodiment of the present invention.

### PREFERRED EMBODIMENTS OF THE INVENTION

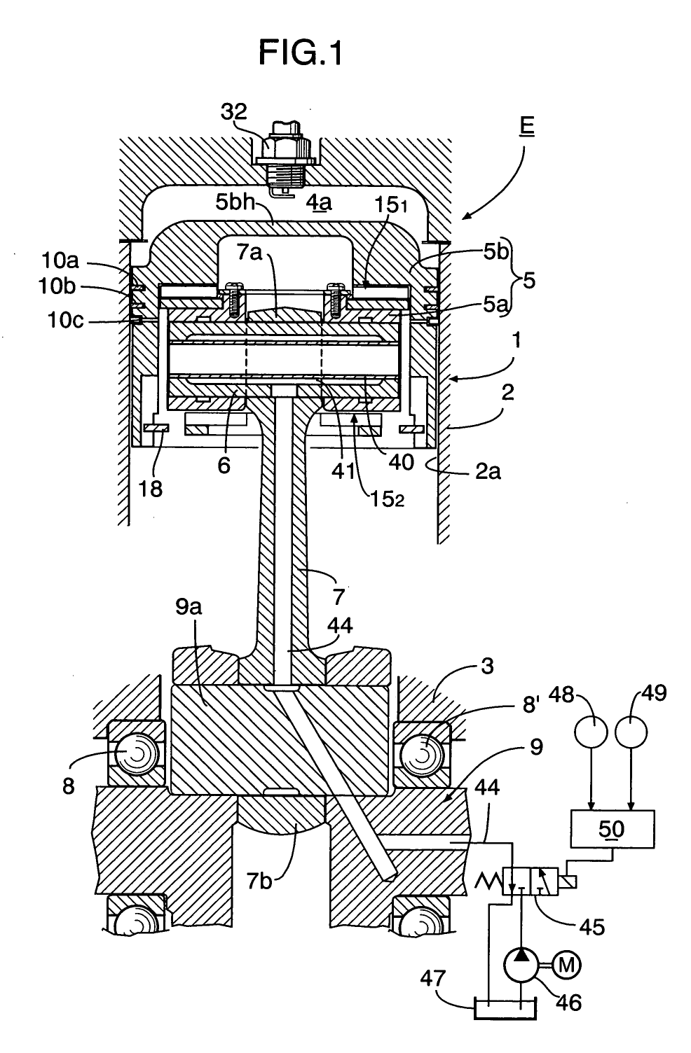

The first embodiment of the present invention is first explained with reference to FIG. 1 to FIG. 15D.

In FIG. 1, an engine main body 1 of an internal combustion engine E includes a cylinder block 2 having a cylinder bore 2a, a crankcase 3 joined to the lower end of the cylinder block 2, and a cylinder head 4 that has a pentroof-shaped combustion chamber 4a extending from the upper end of the cylinder bore 2a and is joined to the upper end of the cylinder block 2. The cylinder head 4 is provided with an intake valve 31i and an exhaust valve 31e for opening and closing an intake port 30i and an exhaust port 30e respectively, the intake port 30i and the exhaust port 30e opening in the roof of the combustion chamber 4a, and a spark plug 32 is screwed into the cylinder head 4, the electrodes of the spark plug 32 facing a central part of the combustion chamber 4a.

A piston 5 is fitted slidably in the cylinder bore 2a, a small end 7a of a connecting rod 7 is connected to the piston 5 via a piston pin 6, and a large end 7b of the connecting rod 7 is connected via a pair of left and right bearings 8 and 8′ to a crankpin 9a of a crankshaft 9 rotatably supported in the crankcase 3.

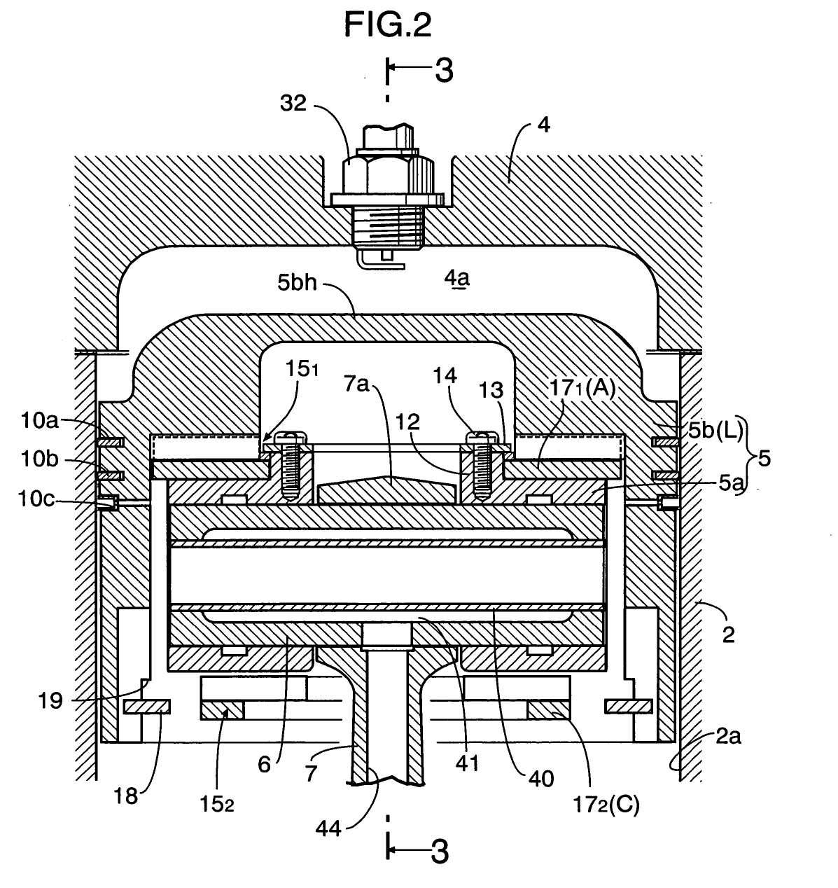

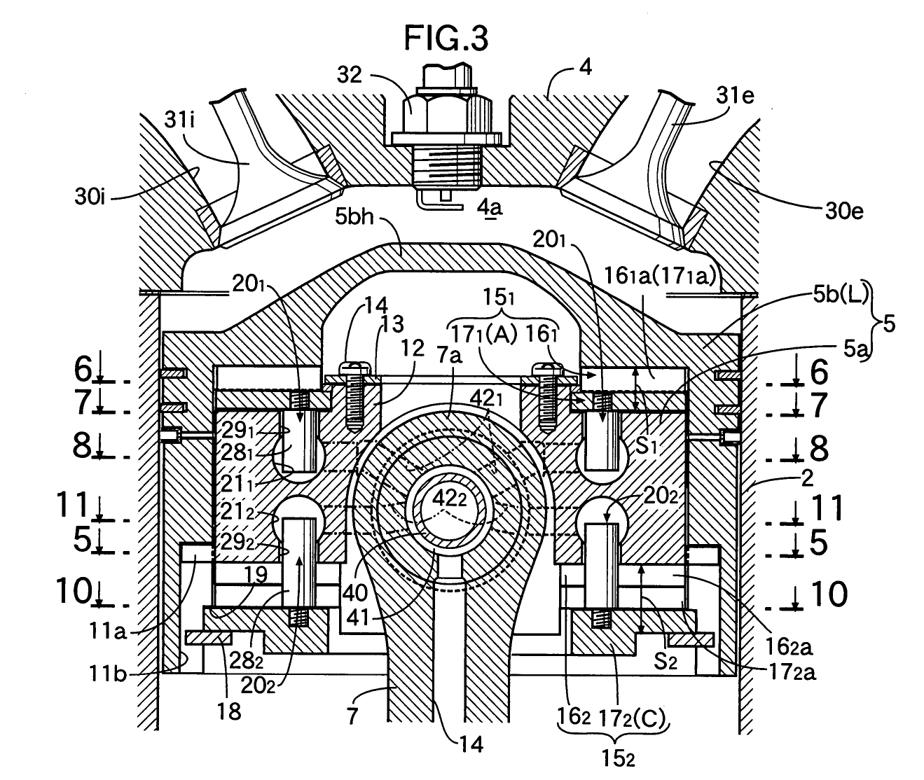

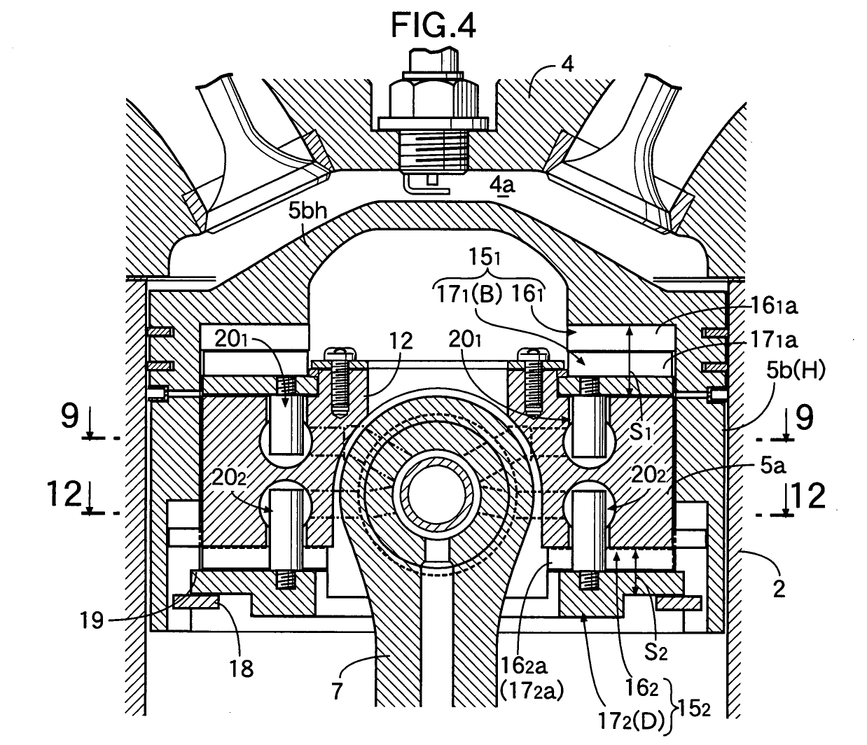

In FIG. 2 to FIG. 4, the piston 5 includes a inner piston 5a and a outer piston 5b, the inner piston 5a being connected to the small end 7a of the connecting rod 7 via the piston pin 6, the outer piston 5b being slidably fitted around an outer peripheral face of the inner piston 5a and being capable of moving on the inner piston 5a between a predetermined low compression ratio position L (see FIG. 3) and a predetermined high compression ratio position H (see FIG. 4). The outer piston 5b is slidably fitted to an inner peripheral face of the cylinder bore 2a via a plurality of piston rings 10a to 10c mounted on the outer periphery of the outer piston 5b, and a head portion 5bh of the outer piston 5b faces the combustion chamber 4a. The head portion 5bh has a peaked shape so as to match the shape of the pent-roof combustion chamber 4a.

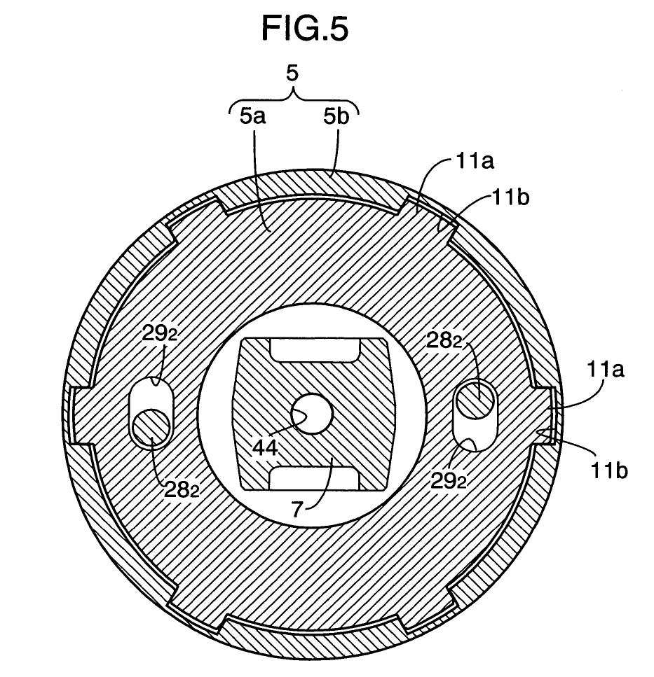

As shown in FIG. 3 and FIG. 5, a plurality of spline teeth 11a and spline grooves 11b extending in the axial direction of the piston 5 and engaging with each other are formed on the sliding mating faces of the inner piston and outer 5a and 5b respectively, thereby preventing relative rotation of the inner piston and outer 5a and 5b around their axes. Furthermore, a retaining ring 18 for restricting axial movement of the inner piston 5a relative to the outer piston 5b is latched to an inner peripheral face of the outer piston 5b so that the inner piston 5a is interposed between the retaining ring 18 and, on the opposite side, the head portion 5bh.

A first cam mechanism 15₁ is disposed between the inner piston 5a and the head portion 5bh so as to control a first axial spacing S₁ therebetween, and a second cam mechanism 15₂ is disposed between the inner piston 5a and the retaining ring 18 so as to control a second axial spacing S₂ therebetween. Increasing and decreasing the first and second axial spacings S₁ and S₂ oppositely to each other by means of these first and second cam mechanisms 15₁ and 15₂ enables the outer piston 5b to be held alternately at the low compression ratio position L, which is close to the piston pin relative to the inner piston 5a, and at the high compression ratio position H, which is close to the combustion chamber 4a relative to the inner piston 5a.

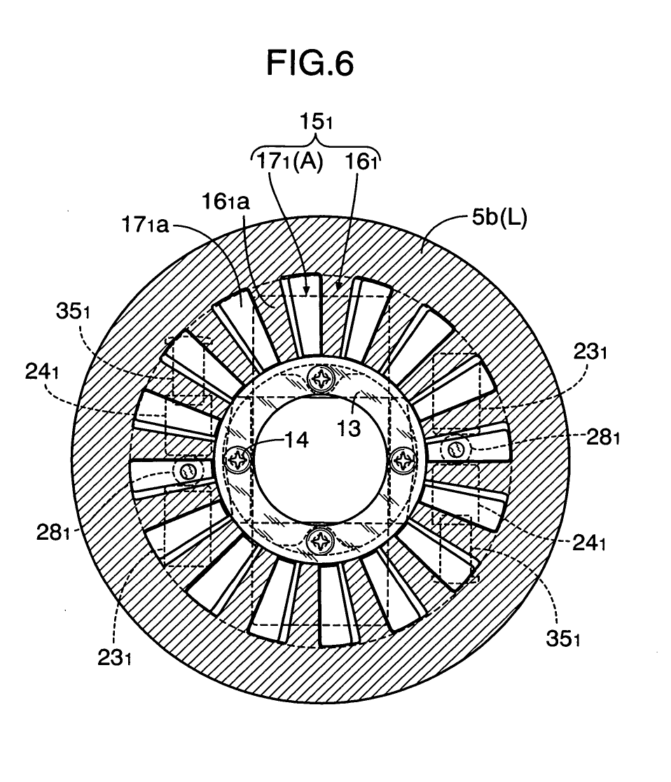

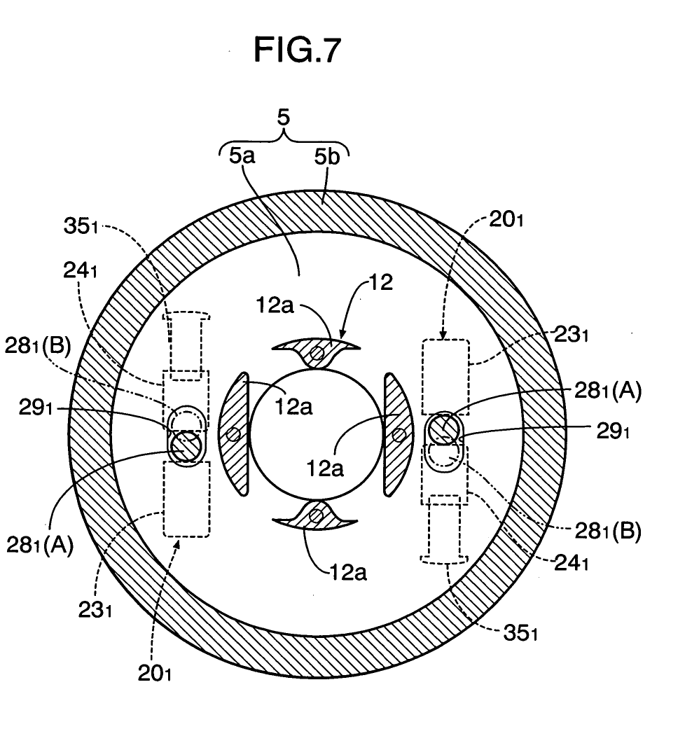

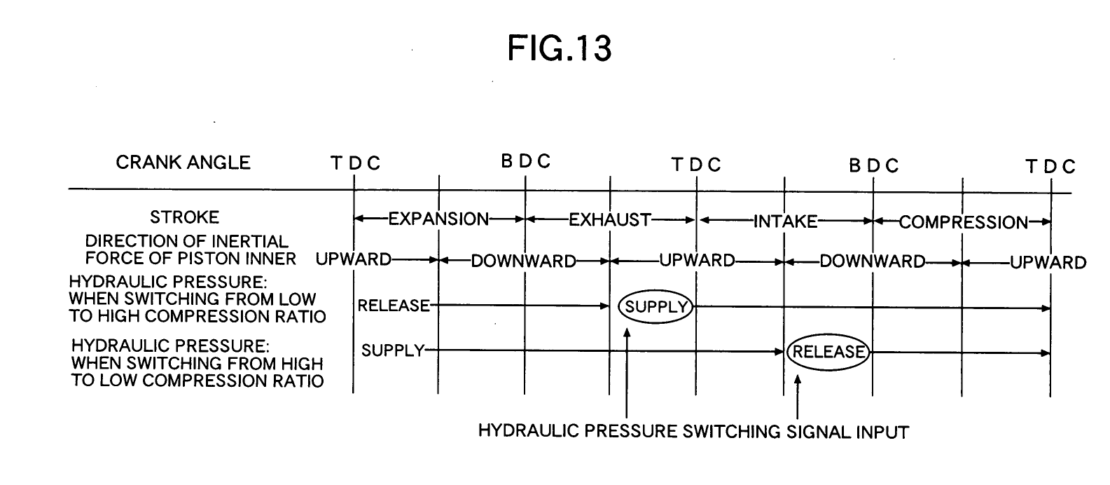

In FIG. 3, FIG. 6, and FIG. 13, the first cam mechanism 15₁, includes an upper first fixed cam 16₁, and a lower first rotating cam plate 17₁, the first fixed cam 16₁, being formed on an inner wall of the head portion 5bh of the outer piston 5b, and the first rotating cam plate 17₁, being supported on an upper face of the inner piston 5a while being pivotably fitted around a pivot portion 12 integrally and projectingly provided on the upper face of the inner piston 5a. The pivot portion 12 is divided into a plurality of blocks 12a (see FIG. 7) so as to receive the small end 7a of the connecting rod 7. Fixed to end faces of these blocks 12a via a plurality of bolts 14 is a retaining plate 13 for blocking axial movement of the first rotating cam plate 17₁, on the pivot portion 12.

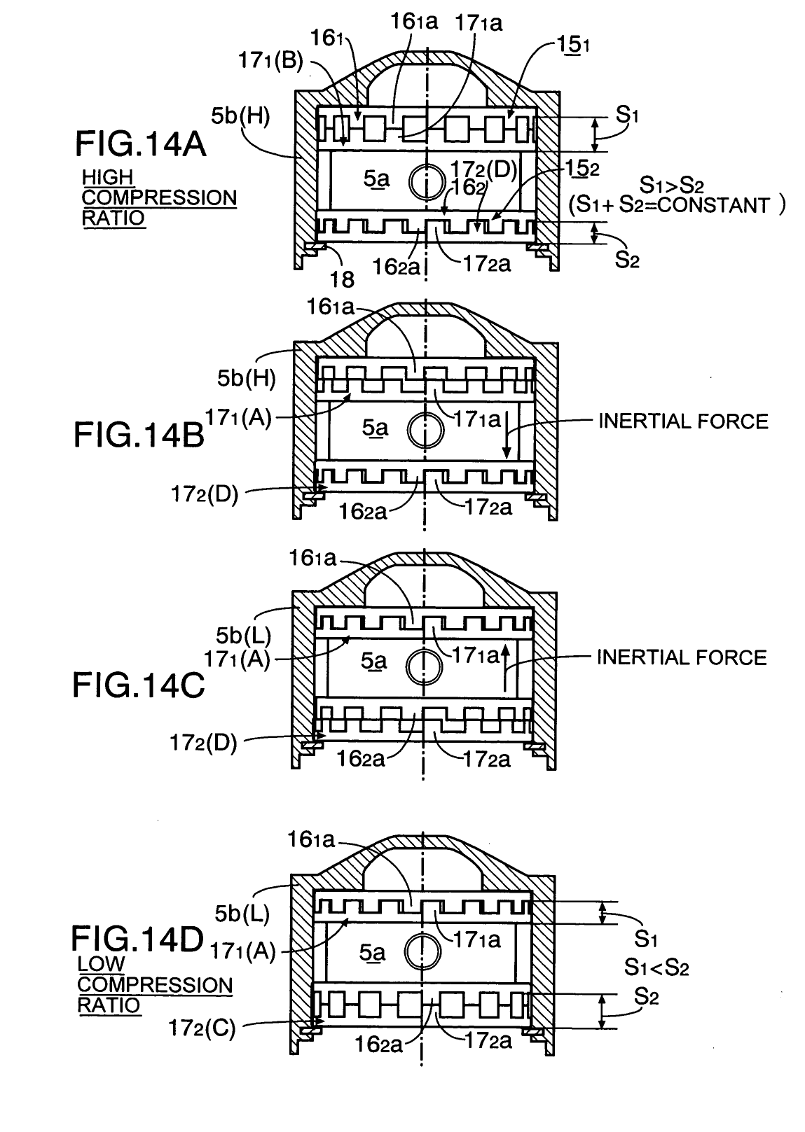

The first rotating cam plate 17₁, is capable of rotating between first and second rotational positions A and B set around the axis thereof, and its reciprocating rotation, in cooperation with the first fixed cam 16₁, increases and decreases the first axial spacing S₁. Specifically, the first fixed cam 16₁ includes a plurality of cam peaks 16₁a arranged in the peripheral direction, and similarly the first rotating cam plate 17₁ is provided integrally with a plurality of cam peaks 17₁ arranged in the peripheral direction. Each of the cam peaks 16₁a and 17₁a of the first fixed cam 16₁ and the first rotating cam plate 17₁ has a rectangular shape, as shown in FIGS. 14A to 14D, in which opposite side faces arranged in the peripheral direction are vertical faces and a top face connecting upper edges of opposite vertical faces is flat.

When the first rotating cam plate 17₁ is at the first rotational position A, the cam peak 16₁a of the upper first fixed cam 16₁ can go in and out of a valley between adjacent cam peaks 17₁a of the first rotating cam plate 17₁ (see FIGS. 14A and 14B), and as a result movement of the outer piston 5b to the low compression ratio position L or the high compression ratio position H is allowed. When the upper and lower cam peaks 16₁a and 17₁a mesh with each other, the first cam mechanism 15₁ is in an axially compressed state, thus decreasing the first axial spacing S₁.

On the other hand, when the first rotating cam plate 17₁ is at the second rotational position B, the flat tops of the cam peaks 16₁a and 17₁a of the first fixed cam 16₁ and the first rotating cam plate 17₁ abut against each other (see FIG. 14A), and the first cam mechanism 15₁ is thus in an axially expanded state, thereby increasing the first axial spacing S₁ and holding the outer piston 5b at the high compression ratio position H.

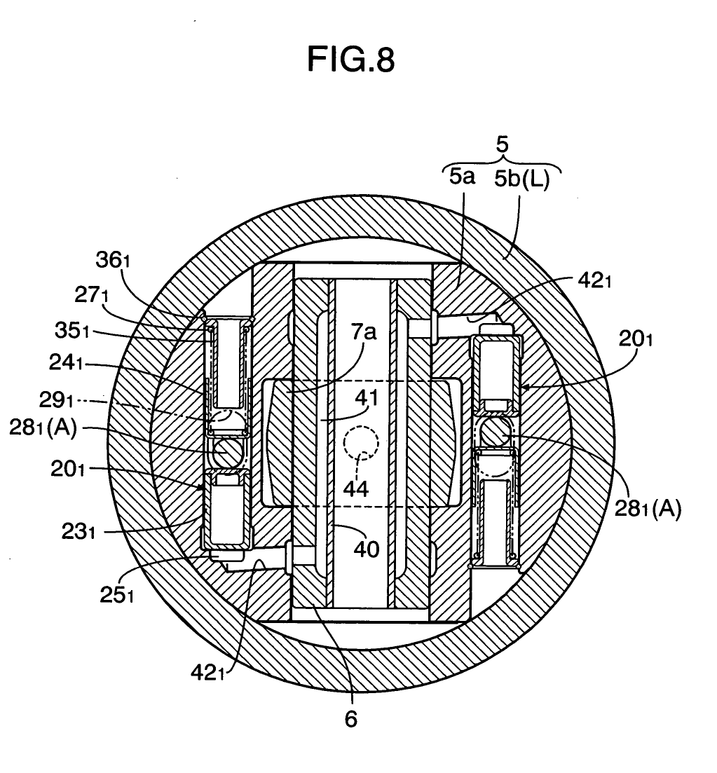

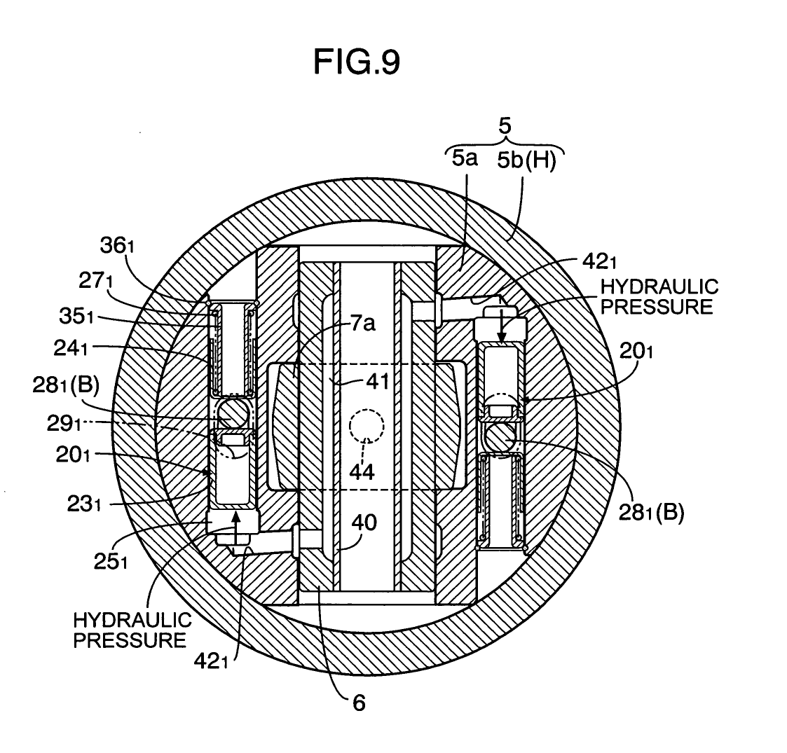

Provided between the inner piston 5a and the first rotating cam plate 17₁ is a first actuator 20₁ for rotating the first rotating cam plate 17₁ alternately to the first rotational position A and the second rotational position B. This first actuator 20₁ is explained with reference to FIG. 3, FIG. 4, FIG. 8, and FIG. 9.

The inner piston 5a is provided with a pair of bottomed cylinder holes 21₁ extending parallel to the piston pin 6 on either side thereof, and long holes 29₁ running through an upper wall of a middle section of each of the cylinder holes 21₁. A pair of pressure-receiving pins 28₁ projectingly provided integrally with a lower face of the first rotating cam plate 17₁ and arranged on a diameter thereof run through the long holes 29₁, face the cylinder holes 21₁. The long holes 29₁ are arranged so that the pressure-receiving pins 28₁ are not prevented from moving together with the first rotating cam plate 17₁ between the first rotational position A and the second rotational position B.

An operating plunger 23₁ and a bottomed cylindrical return plunger 24₁ are fitted slidably in each of the cylinder holes 21₁ with the corresponding pressure-receiving pin 28₁ interposed therebetween. In this arrangement, the operating plungers 23₁ and the return plungers 24₁ are each disposed point-symmetrically relative to the axis of the piston 5.

A first hydraulic chamber 25₁ is defined within each of the cylinder holes 21₁, the inner end of the operating plunger 23₁ facing the first hydraulic chamber 25₁. When hydraulic pressure is supplied to the chamber 25₁ the operating plunger 23₁ receives the hydraulic pressure and rotates the first rotating cam plate 17₁ to the second rotational position B via the pressure-receiving pin 28₁.

Moreover, a cylindrical spring retaining tube 35₁ is latched at an end portion on the open side of each of the cylinder holes 21₁ via a retaining ring 36₁, and a return spring 27₁ is provided under compression between the spring retaining tube 35₁ and the return plunger 24₁, the return spring 27₁ urging the return plunger 24₁ toward the pressure-receiving pin 28₁.

In this way, the first rotational position A of the first rotating cam plate. 17₁ is defined by each of the pressure-receiving pins 28₁ abutting against the extremity of the operating plunger 23₁, which abuts against the bottom face of the cylinder hole 21₁ (see FIG. 8), and the second rotational position B of the first rotating cam plate 17₁ is defined by the return plunger 24₁, which is pushed by the pressure-receiving pin 28₁, abutting against the extremity of the spring retaining tube 35₁ (see FIG. 9).

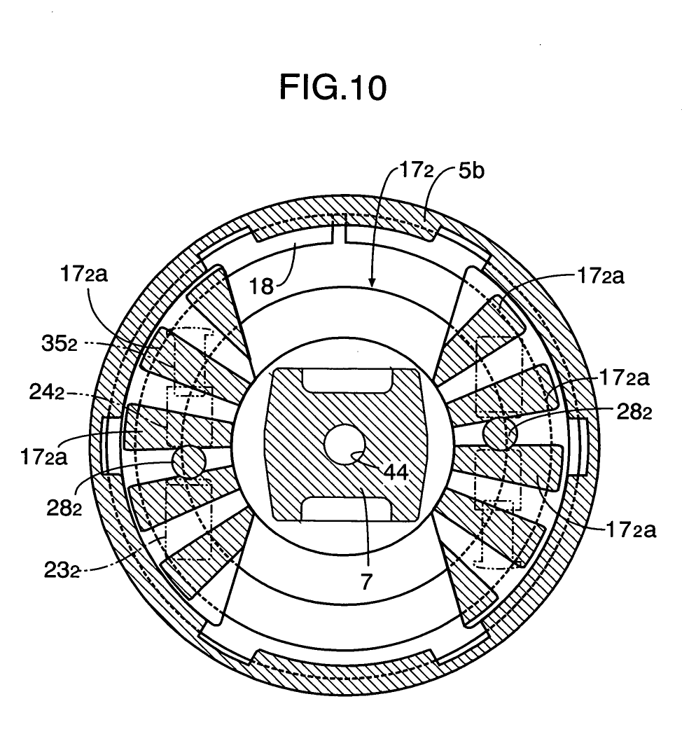

In FIG. 3, FIG. 10, and FIGS. 14A to 14D, the second cam mechanism 15₂ includes an upper second fixed cam 16₂ and a lower second rotating cam plate 17₂, the second fixed cam 16₂ being formed on a lower end wall of the inner piston 5a, and the second rotating cam plate 17₂ being rotatably fitted to an inner peripheral face of the outer piston 5b above the retaining ring 18. An annular shoulder 19 is formed on the inner periphery of the outer piston 5b, the shoulder 19 abutting against an upper face of the second rotating cam plate 17₂, and this shoulder 19 and the retaining ring 18 hold the second rotating cam plate 17₂ so that it can rotate but is prevented from axially moving relative to the outer piston 5b.

The second rotating cam plate 17₂ is capable of rotating between a third rotational position C and a fourth rotational position D set around the axis thereof, and its reciprocating rotation, in cooperation with the second fixed cam 16₂, increases and decreases the second axial spacing S₂. Specifically, the second fixed cam 16₂ includes a plurality of cam peaks 16₂a arranged in the peripheral direction, and similarly the second rotating cam plate 17₂ is integrally provided with a plurality of cam peaks 17₂a arranged in the peripheral direction. Each of the cam peaks 16₁a and 17₁a of the first fixed cam 16₁ and the first rotating cam plate 17₁ has a rectangular shape in which opposite side faces arranged in the peripheral direction are vertical faces and a top face connecting upper edges of opposite vertical faces is flat. The rotational angle between the third and fourth rotational positions C and D of the second rotating cam plate 17₂ is set so as to be identical to the rotational angle between the first and second rotational positions A and B of the first rotating cam plate 17₁. Furthermore, at least the effective heights of the cam peaks 16₂a and 17₂a of the second fixed cam 16₂ and the second rotating cam plate 17₂ are set so as to be identical to those of the cam peaks 16₁a and 17₂a of the first fixed cam 16₁ and the first rotating cam plate 17₁. In the illustrated case, the cam peaks 16₂a and 17₂a are formed so as to have the same shape as that of the cam peaks 16₁a and 17₂a. The second fixed cam 16₂ and the second rotating cam plate 17₂ are provided with sections where no cam peak is present in order to avoid interference with a pin boss portion that supports the piston pin 6 of the inner piston 5a (see FIG. 10).

When the second rotating cam plate 17₂ is at the third rotational position C, the flat top faces of the cam peaks 16₂a and 17₂a of the second fixed cam 16₂ and the second rotating cam plate 17₂ abut against each other (see FIG. 14D), so that the second cam mechanism 15₂ is in an axially expanded state, thus increasing the second axial spacing S₂ and holding the outer piston 5b at the low compression ratio position L.

When the second rotating cam plate 17₂ is at the fourth rotational position D, the cam peak 16₂a of the second fixed cam 16₂ can go in and out of a valley between adjacent cam peaks 17₂a of the second rotating cam plate 17₂ (see FIGS. 14A and 14C), and as a result movement of the outer piston 5b to the low compression ratio position L or the high compression ratio position H is allowed. When the upper and lower cam peaks 16₂a and 17₂a mesh with each other, the second cam mechanism 15₂ is in an axially compressed state, thus decreasing the second axial spacing S₂.

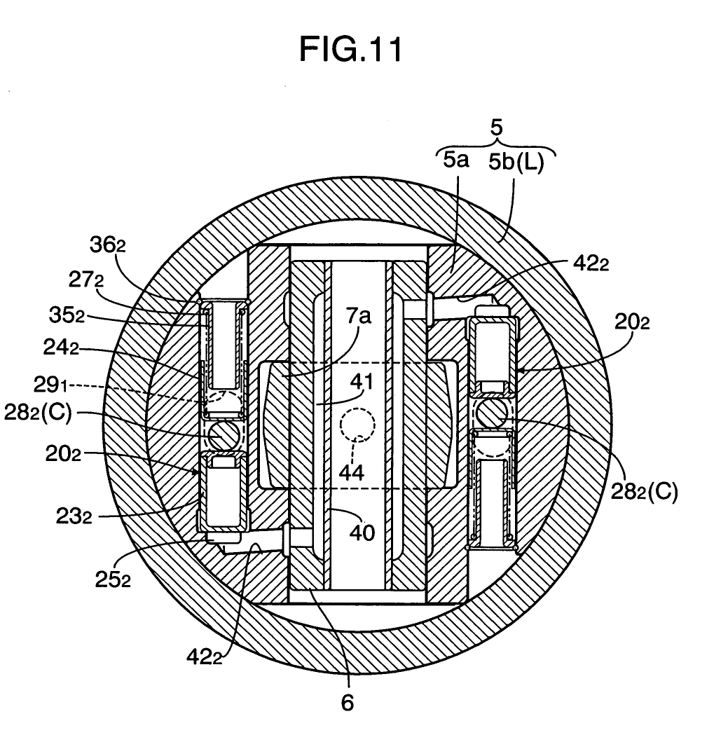

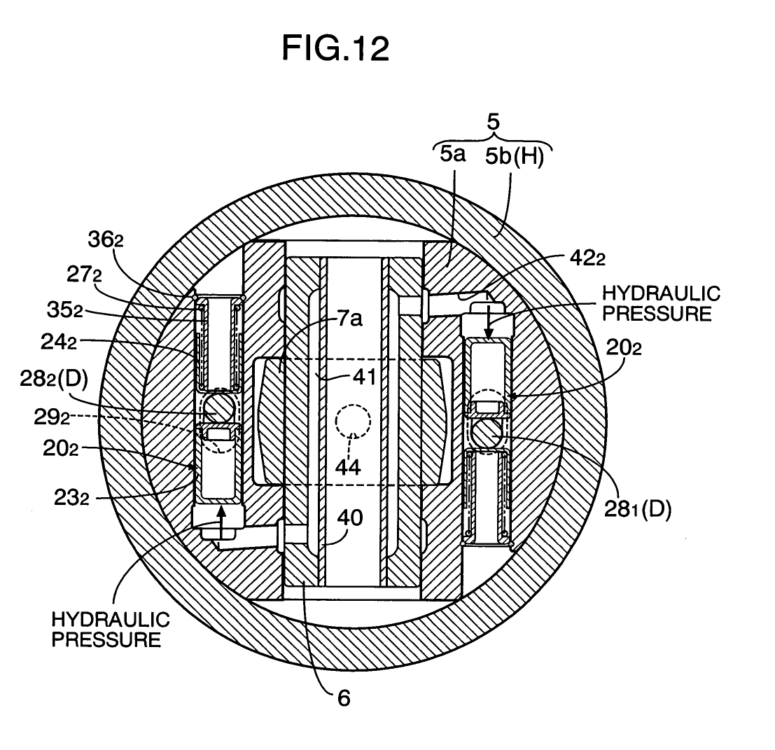

Provided between the inner piston 5a and the second rotating cam plate 17₂ is a second actuator 20₂ for rotating the second rotating cam plate 17₂ alternately to the third rotational position C and the fourth rotational position D. This second actuator 20₂ is explained with reference to FIG. 3, FIG. 4, FIG. 11, and FIG. 12.

The structures of the second actuator 20₂ and the first actuator 20₁ are symmetrical. That is, the inner piston 5a is provided with a pair of bottomed cylinder holes 21₂ extending parallel to the piston pin 6 on either side thereof, and long holes 29₂ running through an upper wall of a middle section of the cylinder holes 21₂. A pair of pressure-receiving pins 28₂ projectingly provided integrally with a lower face of the second rotating cam plate 17₂ and arranged on a diameter thereof run through the long holes 29₂ face the cylinder holes 21₂. The long holes 29₂ are arranged so that the pressure-receiving pins 28₂ are not prevented from moving together with the second rotating cam plate 17₂ between the third rotational position C and the fourth rotational position D.

An operating plunger 23₂ and a bottomed cylindrical return plunger 24₂ are fitted slidably in each of the cylinder holes 21₂ with the corresponding pressure-receiving pin 28₂ interposed therebetween. In this arrangement, the operating plungers 23₂ and the return plungers 24₂ are each disposed point-symmetrically relative to the axis of the piston 5.

A second hydraulic chamber 25₂ is defined within each of the cylinder holes 21₂, the inner end of the operating plunger 23₂ facing the second hydraulic chamber 25₂. When hydraulic pressure is supplied to the chamber 25₂ the operating plunger 23₂ receives the hydraulic pressure and pivots the second rotating cam plate 17₂ to the fourth rotational position D via the pressure-receiving pin 28₂.

Moreover, a cylindrical spring retaining tube 35₂ is latched at an end portion on the open side of each of the cylinder holes 21₂ via a retaining ring 36₂, and a return spring 27₂ is provided under compression between the spring retaining tube 35₂ and the return plunger 24₂, the return spring 27₂ urging the return plunger 24₂ toward the pressure-receiving pin 28₂.

In this way, the third rotational position C of the second rotating cam plate 17₂ is defined by each of the pressure-receiving pins 28₂ abutting against the extremity of the operating plunger 23₂, which abuts against the bottom face of the cylinder hole 21₂ (see FIG. 11), and the fourth rotational position D of the second rotating cam plate 17₂ is defined by the return plunger 24₂, which is pushed by the pressure-receiving pin 28₂, abutting against the extremity of the spring retaining tube 35₂ (see FIG. 12).

In the above-mentioned arrangement, the first rotating cam plate 17₁ and the first actuator 20₁, and the second rotating cam plate 17₂ and the second actuator 20₂ allow the outer piston 5b to move between the low compression ratio position L and the high compression ratio position H by virtue of an external force that makes the inner piston and outer 5a and 5b move toward or away from each other in the axial direction, such as a difference in inertial force between the inner piston 5a and the outer piston 5b, the frictional resistance between the outer piston 5b and the inner face of the cylinder bore 2a, or negative or positive pressure acting on the outer piston 5b from the combustion chamber 4a side. Since opposite side faces of each of the upper and lower cam peaks 16₁a and 17₁a, and 16₂a and 17₂a are vertical faces, it is possible to reduce the gaps in the peripheral direction between adjacent cam peaks 16₁a and 17₁a, and 16₂a and 17₂a, and it is also possible to set a large total area for the top faces of the cam peaks 16₁a and 17₁a, and 16₂a and 17₂a.

Referring again to FIG. 1 and FIG. 2, a tubular oil chamber 41 is defined between the piston pin 6 and a sleeve 40 press-fitted in a hollow portion of the piston pin 6, and first and second oil distribution passages 42₁ and 42₂ providing a connection between the oil chamber 41 and the hydraulic chambers 25₁ and 25₂ of the first and second actuators 20₁ and 20₂ are provided across the piston pin 6 and the inner piston 5a. As shown in FIG. 1, the oil chamber 41 is connected to an oil passage 44 that is provided across the piston pin 6, the connecting rod 7, and the crankshaft 9, and this oil passage 44 is switchably connected, via a solenoid control valve 45, to an oil pump 46, which is a hydraulic source, and to an oil reservoir 47. A drive circuit 50 is connected to the solenoid control valve 45, and operating condition determining means 48 is connected to the drive circuit 50. This operating condition determining means 48 determines, from the rotational speed, the load, etc. of the engine, whether the engine should be in the low compression ratio state or the high compression ratio state. When it is determined that the engine should be in the low compression ratio state, the drive circuit 50 puts the solenoid control valve 45 in a non-energized state, and when it is determined that the engine should be in the high compression ratio state, the drive circuit 50 puts the solenoid control valve 45 in an energized state. The solenoid control valve 45 opens the oil passage 44 to the oil reservoir 47 in the non-energized state, and connects the oil pump 46 to the oil passage 44 in the energized state.

Furthermore, a piston position sensor 49 is connected to the drive circuit 50: when the solenoid control valve 45 is energized in order to switch from the low compression ratio state to the high compression ratio state, its energization is started at the midpoint of the exhaust stroke of the piston 5 based on an output signal from the piston position sensor 49; and when the solenoid control valve 45 is de-energized in order to switch from the high compression ratio state to the low compression ratio state, its de-energization is started at the midpoint of the intake stroke of the piston 5 based on an output signal from the piston position sensor 49.

The operation of the first embodiment is now explained.

### Switching from High Compression Ratio Position to Low Compression Ratio Position (see FIG. 13 and FIGS. 14A to 14D)

Assume that, as shown in FIG. 14A, the outer piston 5b is held at the high compression ratio position H. That is, in the first cam mechanism 15₁ the upper and lower cam peaks 16₁a and 17₁a are in the axially expanded state in which top faces thereof are facing each other, and in the second cam mechanism 15₂ the upper and lower cam peaks 16₂a and 17₂a are in the axially compressed state in which they are meshed with each other.

When, for example, the internal combustion engine E is being rapidly accelerated and is in a state in which knocking easily occurs, the operating condition determining means 48 determines that the engine should be in the low compression ratio state, and the solenoid control valve 45 is put in a non-energized state as shown in FIG. 1, thus opening the oil passage 44 to the oil reservoir 47. With this operation, the hydraulic chambers 25₁ and 25₂ of the first and second actuators 20₁ and 20₂ are both opened to the oil reservoir 47 via the oil chamber 41 and the oil passage 44. Therefore, in the first actuator 20₁ the return plunger 24₁ pushes the pressure-receiving pin 28₁ by virtue of the urging force of the return spring 27₁ so as to rotate the first rotating cam plate 17₁ to the first rotational position A, and in the second actuator 20₁ the return plunger 24₂ pushes the pressure-receiving pin 28₂ by virtue of the urging force of the return spring 27₂ so as to rotate the second rotating cam plate 17₂ to the third rotational position C.

Since the de-energization of the solenoid control valve 45 is started at the midpoint of intake stroke of the piston 5, in the second half of the intake stroke a downward inertial force acts on the inner piston 5a prior to acting on the outer piston 5b, and thus the first cam mechanism 15₁ is released from the thrust load between the inner piston 5a and the outer piston 5b. Therefore, the first rotating cam plate 17₁ is first quickly rotated to the first rotational position A via the pressure-receiving pin 28₁ by virtue of the urging force of the return spring 27₁ of the first actuator 20₁ (see FIG. 8).

As a result, as shown in FIG. 14B, the upper and lower cam peaks 16₁a and 17₁a of the first cam mechanism 15₁ are in a configuration in which they are displaced from each other by half the pitch and can mesh with each other.

Subsequently, when the piston 5 comes to the second half of the compression stroke, an upward inertial force acts on the inner piston 5a prior to acting on the outer piston 5b, so that the outer piston 5b descends relative to the inner piston 5a as shown in FIG. 14C while making the upper and lower cam peaks 16₁a and 17₁a of the first cam mechanism 15₁ mesh with each other, that is, while making the first cam mechanism 15₁ compress in the axial direction, thus occupying the low compression ratio position L.

In this way, when the outer piston 5b descends relative to the inner piston 5a, in the second cam mechanism 15₂ the second rotating cam plate 17₂ descends relative to the second fixed cam 16₂, the upper and lower cam peaks 16₂a and 17₂a are accordingly released from the meshed state, and the second rotating cam plate 17₂ is therefore quickly rotated to the third rotational position C via the pressure-receiving pin 28₂ by virtue of the urging force of the return spring 27₂ of the second actuator 20₂ (see FIG. 11).

As a result, as shown in FIG. 14D, the flat top faces of the upper and lower cam peaks 16₂a and 17₂a of the second cam mechanism 15₂ are made to abut against each other. Due to this kind of axial expansion of the second cam mechanism 15₂ the second axial spacing S₂ increases, thereby holding the outer piston 5b at the low compression ratio position L.

In this way, the inner piston 5a and the outer piston 5b are securely connected to each other by the first cam mechanism 15₁ in the axially compressed state and the second cam mechanism 15₂ in the axially expanded state while holding the outer piston 5b at the low compression ratio position L, thereby putting the internal combustion engine E in a low compression ratio state.

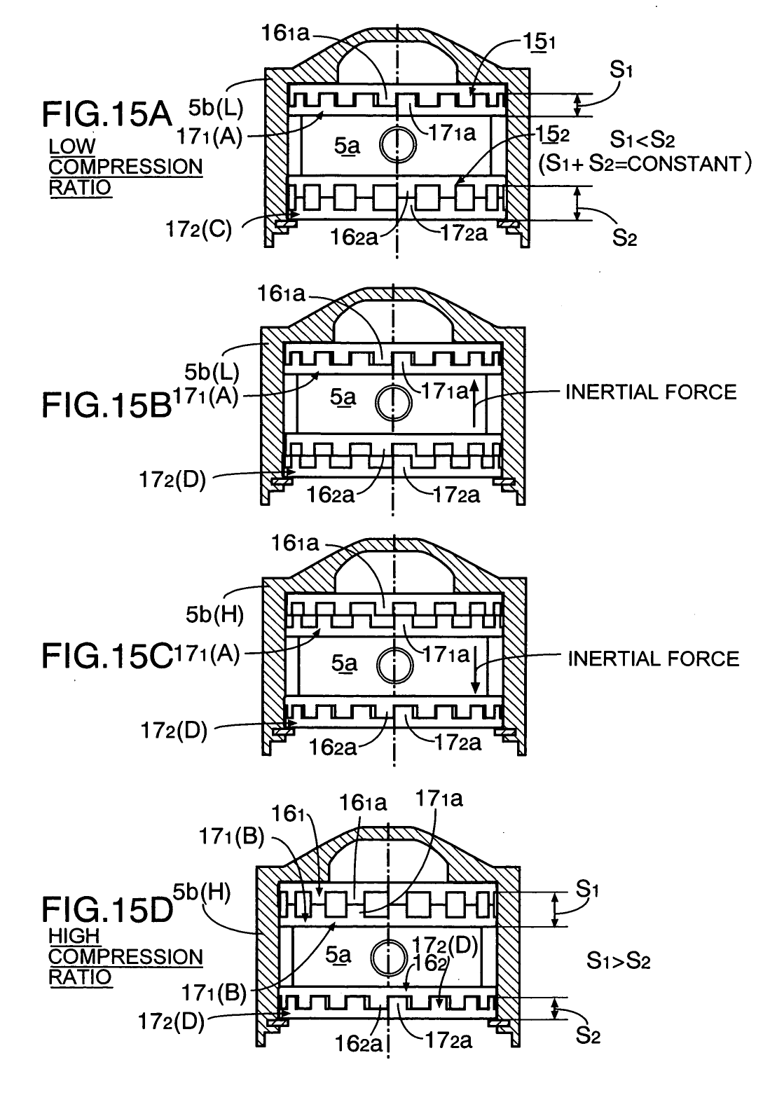

Switching from Low Compression Ratio Position to High Compression Ratio Position (see FIG. 13 and FIGS. 15A to 15D)

Subsequently, for example when the internal combustion engine E is being operated at high speed, the operating conditions determining means 48 determines that the engine should be in the high compression ratio state, and the solenoid control valve 45 is put in an energized state, thus connecting the oil passage 44 to the oil pump 46. Since hydraulic pressure discharged from the oil pump 46 is supplied to all the hydraulic chambers 25₁ and 25₂ via the oil passage 44 and the oil chamber 41, in the first actuator 20₁ the operating plunger 23₁ receives the hydraulic pressure from the first hydraulic chamber 25₁ and attempts to rotate the first rotating cam plate 17₁ toward the second rotational position B via the pressure-receiving pin 28₁, and in the second actuator 20₂ the operating plunger 23₂ receives the hydraulic pressure from the second hydraulic chamber 25₂ and attempts to rotate the second rotating cam plate 17₂ toward the fourth rotational position D via the pressure-receiving pin 28₂.

Since energization of the solenoid control valve 45 is started at the midpoint of exhaust stroke of the piston 5, in the second half of the exhaust stroke the inner piston 5a receives an upward inertial force before the outer piston 5b receives it, and the second cam mechanism 15₂ disposed between the inner piston 5a and the retaining ring 18 is therefore released from the thrust load. The second rotating cam plate 17₂ is therefore first quickly rotated to the fourth rotational position D via the pressure-receiving pin 28₂ by virtue of the pressing force due to the hydraulic pressure of the operating plunger 23₂ of the second actuator 20₂ (see FIG. 12).

As a result, as shown in FIG. 15B, the upper and lower cam peaks 16₂a and 17₂a of the second cam mechanism 15₂ are in a configuration in which they are displaced from each other by half the pitch and can mesh with each other.

Subsequently, when the piston 5 reaches the second half of the intake stroke, since a downward inertial force acts on the inner piston 5a prior to acting on the outer piston 5b, the outer piston 5b ascends relative to the inner piston 5a as shown in FIG. 15C while making the upper and lower cam peaks 16₂a and 17₂a of the second cam mechanism 152 mesh with each other, that is, while making the second cam mechanism 152 compress in the axial direction, thus occupying the high compression ratio position H.

In this way, when the outer piston 5b ascends relative to the inner piston 5a, in the first cam mechanism 15₁ the first fixed cam 16₁ ascends relative to the first rotating cam plate 17₁, the upper and lower cam peaks 16₂a and 17₂a are accordingly released from the meshed state, and the first rotating cam plate 17₁ is therefore quickly rotated to the second rotational position B via the pressure-receiving pin 28₂ by virtue of the pushing force, due to hydraulic pressure, of the operating plunger 23₁ of the first actuator 20₁ (see FIG. 9).

As a result, as shown in FIG. 14D, the flat top faces of the upper and lower cam peaks 16₁a and 17₁a of the first cam mechanism 15₁ are made to abut against each other. Due to this kind of axial expansion of the first cam mechanism 15₁, the first axial spacing S₁ increases, thereby holding the outer piston 5b at the high compression ratio position H.

In this way, the inner piston 5a and the outer piston 5b are securely connected to each other by the first cam mechanism 15₁ in the axially expanded state and the second cam mechanism 15₂ in the axially compressed state while holding the outer piston 5b at the high compression ratio position H, thereby putting the internal combustion engine E in a high compression ratio state.

In this case, particularly because the first rotating cam plate 17₁ is supported on the inner piston 5a in an axially immovable manner by the retaining plate 13₁ and the second rotating cam plate 17₂ is supported on the outer piston 5b in an axially immovable manner by the retaining ring 18 and the shoulder 19, there is no axial play in either cam plate. Therefore, when the first cam mechanism 15₁ and the second cam mechanism 15₂ expand and compress alternately by utilizing an external force such as a difference in inertial force between the inner piston and outer 5a and 5b, it is possible to reliably avoid interference between the first fixed cam 16₁ and the first rotating cam plate 17₁, and between the second fixed cam 16₂ and the first rotating cam plate 17₁; to allow each of the rotating cam plates 17₁ and 17₂ to reliably rotate to the respective desired rotational positions by the driving forces of the first and second actuators 20₁ and 20₂; and to reliably hold the outer piston 5b at a desired low compression ratio position L and high compression ratio position H.

Furthermore, since the inner piston 5a and the outer piston 5b are always connected securely to each other in the axial direction via the first and second cam mechanisms 15₁ and 15₂ regardless of whether the outer piston 5b is at the low compression ratio position L or the high compression ratio position H, the thrust load working between the inner piston 5a and the outer piston 5b can always be borne mechanically by either the first or second cam mechanism 15₁ or 15₂, thus increasing the piston strength effectively and thereby enabling the capacity of the first and second actuators 20₁ and 20₂, and consequently the dimensions thereof, to be reduced.

In particular, since an external force such as a difference in inertial force between the inner piston 5a and the outer piston 5b, the sliding resistance between the outer piston 5b and the cylinder bore inner face, and the negative pressure and positive pressure on the combustion chamber 4a side can be utilized effectively for moving the outer piston 5b to the low compression ratio position L or the high compression ratio position H, and the first and second actuators 20₁ and 20₂ for rotating the first and second cam plates 17₁ and 17₂ receive a zero or extremely small thrust load from the inner piston 5a and the outer piston 5b, it is possible to reduce the load of the first and second actuators 20₁ and 20₂, and further reduce the capacity and, consequently, the dimensions thereof.

Furthermore, when the outer piston 5b moves between the low compression ratio position L and the high compression ratio position H, since its rotation relative to the inner piston 5a is restrained by the spline teeth 11a and the spline grooves 11b that are formed on the mating faces of the inner piston 5a and the outer piston 5b and that are slidably engaged with each other, it is possible to effectively increase the compression ratio when the outer piston 5b is at the high compression ratio position H by making the shape of the head portion 5bh of the outer piston 5b facing the combustion chamber 4a match the shape of the combustion chamber 4a, and it therefore becomes possible to employ the five sided roof-shaped combustion chamber 4a as illustrated.

Moreover, since the thrust load acting on the first and second actuators 20₁ and 20₂ by the inner piston 5a and the outer piston 5b is zero or extremely small, even if some bubbles are present in oil of the hydraulic chambers 25₁ and 25₂ of the first and second actuators 20₁ and 20₂, it is possible to hold the outer piston 5b stably at the high compression ratio position H or the low compression ratio position L, and no problems are caused.

Furthermore, since the first and second actuators 20₁ and 20₂ include the hydraulic chambers 25₁ and 25₂, the operating plungers 23₁ and 23₂, the return springs 27₁ and 27₂, and the return plungers 24₁ and 24₂ respectively, it is only necessary to employ one of the hydraulic chambers 25₁ and 25₂ for each of the actuators 20₁ and 20₂. Moreover, since the operating plungers 23₁ and 23₂ and the return plungers 24₁ and 24₂ are fitted in the common cylinder holes 21₁ and 21₂ provided in the inner piston 5a, it is possible to simplify the structure of the first and second actuators 20₁ and 20₂.

Furthermore, since a plurality of sets of the first and second actuators 20₁ and 20₂ are disposed at equal gaps around the rotational axis of the first and second rotating cam plates 17₁ and 17₂ respectively, it is possible to pivot the first and second rotating cam plates 17₁ and 17₂ smoothly around their axes without imposing an uneven load. Moreover, since the total output of the plurality of the first and second actuators 20₁ and 20₂ is large, it is possible to reduce the capacity of the first and second actuators 20₁ and 20₂ and, consequently, the dimensions thereof.

Furthermore, in the first and second actuators 20₁ and 20₂, since the operating and return plungers 23₁ and 24₁, and 23₂ and 24₂ are arranged so that their axes are substantially perpendicular to the radii of the first and second rotating cam plates 17₁ and 17₂, the radii crossing the axes of the pressure-receiving pins 28₁ and 28₂, it is possible to transfer efficiently the pressing force of the operating and return plungers 23₁ and 24₁, and 23₂ and 24₂ to the first and second rotating cam plates 17₁ and 17₂ via the pressure-receiving pins 28₁ and 28₂, thereby contributing to a reduction in the dimensions of the first and second actuators 20₁ and 20₂.

Moreover, since the end faces of the operating and return plungers 23₁ and 24₁, and 23₂ and 24₂ are in line contact with the corresponding cylindrical outer peripheral faces of the pressure-receiving pins 28₁ and 28₂, the contact area is comparatively large, thus reducing the plane pressure and contributing to an improvement in the durability.

Furthermore, the first actuator 20₁ moves the first rotating cam plate 17₁ to the second rotational position B when operated hydraulically, and the second actuator 20₂ moves the second rotating cam plate 17₂ to the fourth rotational position D when operated hydraulically. Therefore, in the event of the hydraulic system malfunctioning, the action of the return springs 27₁ and 27₂ of the first and second actuators 20₁ and 20₂ enables the outer piston 5b to be automatically moved to and held at the low compression position L.

Moreover, since the hydraulic pressure for the hydraulic chambers 25₁ and 25₂ of the first and second actuators 20₁ and 20₂ is supplied and released by the common control valve 45, it is possible to simplify the hydraulic control system, thereby reducing the cost.

Furthermore, since the hydraulic pressure of the hydraulic chambers 25₁ and 25₂ of the first and second actuators 20₁ and 20₂ starts to be released during the intake stroke of the engine, and the hydraulic pressure starts to be supplied to the hydraulic chambers 25₁ and 25₂ during the exhaust stroke of the internal combustion engine, it is possible to quickly move the outer piston 5b from the high compression ratio position H to the low compression ratio position L or from the low compression ratio position L to the high compression ratio position H by effectively utilizing a difference in inertial force between the inner piston 5a and the outer piston 5b.

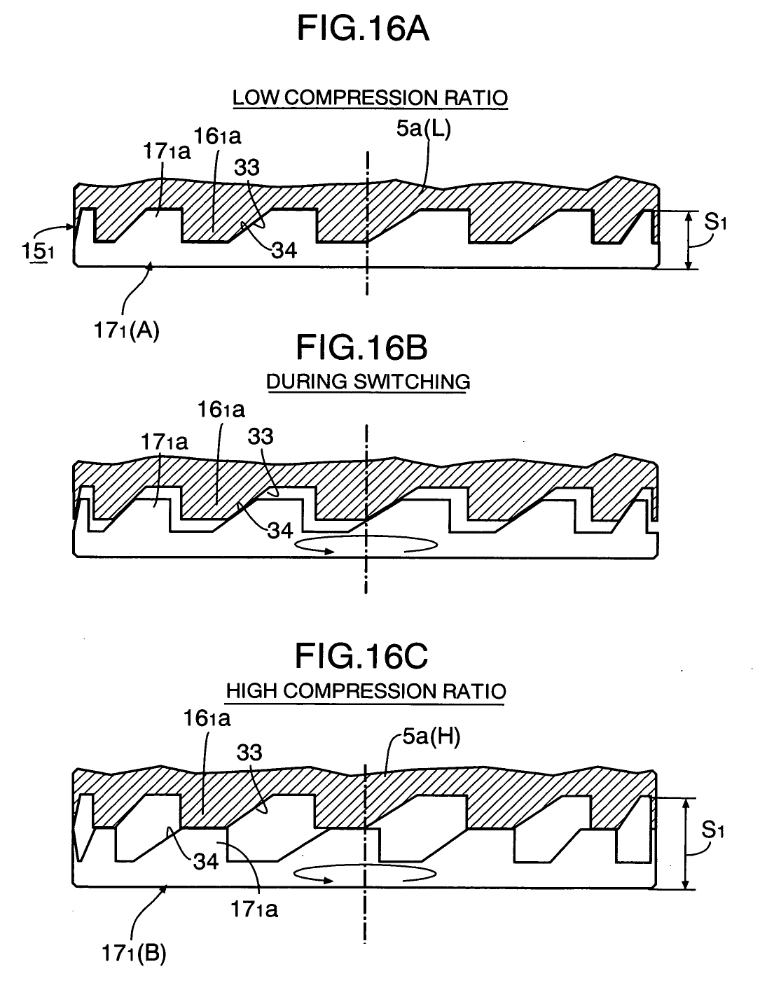

A second embodiment of the present invention shown in FIGS. 16A to 16C is now explained.

This second embodiment has the same arrangement as that of the preceding embodiment except that a cam peak 17₁a of a first rotating cam plate 17₁ and a cam peak 16₁a of a first fixed cam 16₁ formed in a outer piston 5b are provided with inclined faces 33 and 34 so that when the first rotating cam plate 17₁ pivots from a first rotational position A to a second rotational position B, the inclined surfaces 33 and 34 slide away from each other in the axial direction. In FIGS. 16A to 16C, parts corresponding to the parts of the first embodiment are denoted by the same reference numerals and symbols, thereby avoiding duplication of the explanation.

In this second embodiment, since one side of each of the cam peaks 16₁a and 17₁a is formed as the inclined surfaces 33 and 34, compared with the preceding embodiment, the gap between adjacent cams 16₁ and 17₁ increases, the operating stroke angle of the first rotating cam plate 17₁ increases, and the area of the top face of each of the cams 16₁ and 17₁ decreases, but even when the external force for moving the outer piston 5b to the high compression ratio position H is weak, applying a force to the first rotating cam plate 17₁ to pivot it to the second rotational position B using the first actuator 20₁ enables the outer piston 5b to be pushed upward to the high compression ratio position H by the mutual lifting action of the inclined surfaces 33, 34. In this case, although it is not illustrated, the same structure can be employed for the second cam mechanism 15₂.

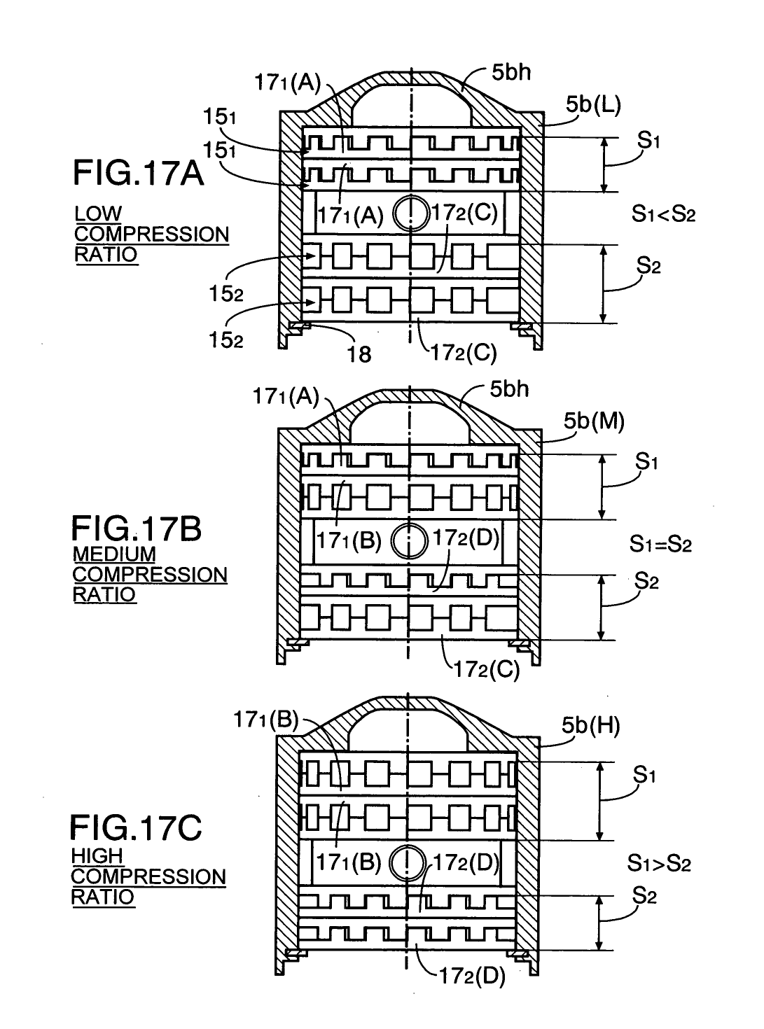

Finally, a third embodiment of the present invention shown in FIGS. 17A to 17C is explained.

This third embodiment is arranged so that in the first embodiment the outer piston 5b can be controlled so as to switch between three positions, that is, a low compression ratio position L, a medium compression ratio position M, and a high compression ratio position. A pair of upper and lower first cam mechanisms 15₁ are disposed between a inner piston 5a and a head portion 5bh of the outer piston 5b, and a pair of upper and lower second cam mechanisms 15₂ are disposed between the inner piston 5a and a retaining ring 18 of the outer piston 5b, thereby enabling the operating states of the upper and lower first cam mechanisms 15₁ to be switched between an in-phase state and an out-of-phase state, and at the same time enabling the operating state of either one of the upper and lower first cam mechanisms 15₁ and the operating state of one of the upper and lower second cam mechanisms 15₂ to be out of phase with each other, and enabling the operating state of the other one of the upper and lower first cam mechanisms 15₁ and the operating state of the other one of the upper and lower second cam mechanisms 15₂ to be out of phase with each other. In FIGS. 17A to 17C, parts corresponding to the parts of the first embodiment are denoted by the same reference numerals and symbols.

As shown in FIG. 17A, by operating both the upper and lower first cam mechanisms 15₁ in an axially compressed state and both the upper and lower second cam mechanisms 15₂ in an axially expanded state, it is possible to control the outer piston 5b at the low compression ratio position L; as shown in FIG. 17B, by operating the upper first cam mechanism 15₁ in an axially compressed state and the lower first cam mechanism 15₁ in an axially expanded state and operating the upper second cam mechanism 15₂ in an axially compressed state and the lower second cam mechanism 15₂ in an axially expanded state, it is possible to control the outer piston 5b at the medium compression ratio position M; and as shown in FIG. 17C, by operating both the upper and lower first cam mechanisms 15₁ in an axially expanded state and operating both the upper and lower second cam mechanisms 15₂ in an axially compressed state, it is possible to control the outer piston 5b at the high compression ratio position H.

The present invention is not limited to the above-mentioned embodiments, and can be modified in a variety of ways without departing from the subject matter of the present invention. For example, the operating mode of the solenoid switch valve 45 can be the opposite of that of the above-mentioned embodiments. That is, an arrangement is possible in which, when the switch valve 45 is in a non-energized state, the oil passage 44 is connected to the oil pump 46, and when it is in an energized state, the oil passage 44 is connected to the oil reservoir 47.

1. An internal combustion engine variable compression ratio system comprising:
an inner piston that is connected to a connecting rod via a piston pin;
an outer piston that has a head portion facing a combustion chamber and that is fitted around the outer periphery of the inner piston so that the outer piston can slide only in the axial direction;
restricting means fixedly provided on the outer piston so as to axially oppose the head portion with the inner piston interposed between the restricting means and the head portion;
a first cam mechanism disposed between the inner piston and the head portion for controlling a first axial spacing therebetween; and
a second cam mechanism disposed between the inner piston and the restricting means for controlling a second axial spacing therebetween,
wherein the first cam mechanism includes a first rotating cam plate that is rotatable between first and second rotational positions around the axis of the inner piston, and is arranged so that the first cam mechanism axially compresses at the first rotational position of the first rotating cam plate so as to allow the first axial spacing to decrease and axially expands at the second rotational position so as to allow the first axial spacing to increase;
wherein the second cam mechanism includes a second rotating cam plate that is rotatable between third and fourth rotational positions around the axis of the inner piston, and is arranged so that the second cam mechanism axially expands at the third rotational position of the second rotating cam plate so as to allow the second axial spacing to increase and axially compresses at the fourth rotational position so as to allow the second axial spacing to decrease; and
wherein the first and second rotating cam plates are connected to driving means for moving the first rotating cam plate to the first rotational position and moving the second rotating cam plate to the third rotational position so as to hold the outer piston at a low compression ratio position, and for moving the first rotating cam plate to the second rotational position and moving the second rotating cam plate to the fourth rotational position so as to hold the outer piston at a high compression ratio position.

2. The internal combustion engine variable compression ratio system according to claim 1, wherein the driving means comprises:
a first actuator comprising first hydraulic operating means for moving the first rotating cam plate toward one of the first and second rotational positions and a first return spring urging the first rotating cam plate toward the other of the first and second rotational positions; and
a second actuator comprising second hydraulic operating means for moving the second rotating cam plate toward one of the third and fourth rotational positions and a second return spring urging the second rotating cam plate toward the other of the third and fourth rotational positions.

3. The internal combustion engine variable compression ratio system according to claim 2,
wherein the first hydraulic operating means is arranged so as to move the first rotating cam plate to the second rotational position when operated hydraulically, and
wherein the second hydraulic operating means is arranged so as to move the second rotating cam plate to the fourth rotational position when operated hydraulically.

4. The internal combustion engine variable compression ratio system according to claim 3, wherein supply and release of hydraulic pressure for the first and second hydraulic operating means are carried out by a common control valve.

5. The internal combustion engine variable compression ratio system according to claim 3, wherein release of hydraulic pressure from the first and second hydraulic operating means is started during an intake stroke of the internal combustion engine, and supply of hydraulic pressure to the first and second hydraulic operating means is started during an exhaust stroke of the internal combustion engine.

6. The internal combustion engine variable compression ratio system according to claim 1, wherein there are provided a plurality of the first cam mechanisms and the second cam mechanisms, the numbers thereof being the same.

7. The internal combustion engine variable compression ratio system according to claim 1,
wherein the first rotating cam plate is supported by one of the inner piston and the outer piston in an axially immovable but pivotable manner, and a first fixed cam forming the first cam mechanism in cooperation with the first rotating cam plate is fixedly provided on the other one of the inner piston and the outer piston, and
wherein the second rotating cam plate is supported by one of the inner piston and the outer piston in an axially immovable but pivotable manner, and a second fixed cam forming the second cam mechanism in cooperation with the second rotating cam plate is fixedly provided on the other one of the inner piston and the outer piston.

8. A method for varying a compression ratio in an internal combustion engine, the engine including:
an inner piston that is connected to a connecting rod via a piston pin;
an outer piston that has a head portion facing a combustion chamber and that is fitted around the outer periphery of the inner piston so that the outer piston can slide only in the axial direction;
restricting means fixedly provided on the outer piston so as to axially oppose the head portion with the inner piston interposed between the restricting means and the head portion;
a first cam mechanism disposed between the inner piston and the head portion for controlling a first axial spacing therebetween; and
a second cam mechanism disposed between the inner piston and the restricting means for controlling a second axial spacing therebetween, the method comprising the steps of:
rotating a first rotating cam plate of the first cam mechanism between first and second rotational positions around the axis of the inner piston, thereby axially compressing the first cam mechanism at the first rotational position of the first rotating cam plate allowing the first axial spacing to decrease, and axially expanding the first cam mechanism at the second rotational position allowing the first axial spacing to increase;
rotating a second rotating cam plate of the second cam mechanism between third and fourth rotational positions around the axis of the inner piston, thereby axially expanding the second cam mechanism the third rotational position of the second rotating cam plate allowing the second axial spacing to increase, and axially compressing the second cam mechanism at the fourth rotational position allowing the second axial spacing to decrease, wherein the first and second rotating cam plates are connected to driving means;
moving the first rotating cam plate to the first rotational position, and moving the second rotating cam plate to the third rotational position thereby holding the outer piston at a low compression ratio position; and
moving the first rotating cam plate to the second rotational position and moving the second rotating cam plate to the fourth rotational position so as to hold the outer piston at a high compression ratio position.

9. The method for varying a compression ratio in an internal combustion engine according to claim 8, further comprising the steps of:
moving the first rotating cam plate toward one of the first and second rotational positions, and urging the first rotating cam plate toward the other of the first and second rotational positions; and
moving the second rotating cam plate toward one of the third and fourth rotational positions, and urging the second rotating cam plate toward the other of the third and fourth rotational positions.

10. The method for varying a compression ratio in an internal combustion engine according to claim 9, further comprising the steps of:
moving the first rotating cam plate to the second rotational position when operated hydraulically, and
moving the second rotating cam plate to the fourth rotational position when operated hydraulically.

11. The method for varying a compression ratio in an internal combustion engine according to claim 10, further comprising the steps of:
supplying and releasing a hydraulic pressure for moving the first and the second rotating cam plate with a common control valve.

12. The method for varying a compression ratio in an internal combustion engine according to claim 10, further comprising the steps of:
starting to release hydraulic pressure for moving the first and the second rotating cam plate during an intake stroke of the internal combustion engine, and
starting to supply hydraulic pressure for moving the first and the second rotating cam plate during an exhaust stroke of the internal combustion engine.
